(19) United States
(12) Patent Application Publication
(10) Pub. No.: US 2006/0244254 A1
(43) Pub. Date: Nov. 2, 2006

(54) Template and method for making a template

(75) Inventors: Jilene A. Repp, Hartland, WI (US); Francis A. Yogerst, West Band, WI (US)

Correspondence Address: FOLEY & LARDNER LLP, 777 EAST WISCONSIN AVENUE, MILWAUKEE, WI, 53202-5306, US

(73) Assignee: June Tailor, Inc.

(21) Appl. No.: 11/401,579

(22) Filed: Apr. 11, 2006

Related U.S. Application Data
(60) Provisional application No. 60/675,120, filed on Apr. 27, 2005.

(51) Int. Cl. B42D 15/00

(52) U.S. Cl. 283/117

(57) ABSTRACT

A template for creating decorative shapes includes a flat sheet of material having an internal region surrounded by an external edge. The internal region includes internal cutting guides formed by slots. The slots including straight slots, waveform slots and interconnected slots. The external edge defines external cutting guides including a waveform edge, a straight edge, an arcuate edge and a scalloped edge. A method of making a template includes selecting a sheet of material, and selecting a pattern of external guides having shapes that define a perimeter of the sheet, and selecting a pattern of internal guides having a plurality of slots, and selecting an arrangement of indicia for use with at least one of the guides, and forming the external guides and the internal guides on the sheet.

### CROSS REFERENCE TO RELATED APPLICATIONS

This Application claims the benefit of priority as available under 35 U.S.C. §119(e) to U.S. Provisional Patent Application No. 60/675,120, titled “Template and Method for Making a Template” filed Apr. 27, 2005, which is incorporated herein by reference in its entirety.

### FIELD

The present inventions relate to a template for use with a material. The present inventions more specifically relate to a template and a method for making a template for use in cutting decorative patterns or shapes in a material such as fleece.

### BACKGROUND

It is known to provide a template or ruler that may be used for cutting a material such as a fabric. Certain known templates (such as for garments) are usually formed from paper and “pinned” onto a fabric, so that a user can cut along a pattern on the paper template to cut the fabric into a desired shape. However, such paper-type templates do not typically protect a user's hands from the cutting device and have limited ability for reuse. Other known templates may include a sheet of material having openings or slots for “marking” the fabric so that a user may remove the template and cut the fabric along the markings to provide any number of separate pieces that may be sewn together in a pattern (such as a quilt cover).

However, such known templates do not realize certain advantageous features (and/or combinations of features). Therefore, it would be desirable to provide a template or the like of a type disclosed in the present application that includes any one or more of these or other advantageous features:
1. A template that provides guides for cutting a fabric.
2. A template that provides internal openings formed in certain patterns for cutting one or more decorative shapes in the fabric.
3. A template that provides slots arranged to create geometrically shaped cutouts in the fabric (such as triangles, diamonds, etc.).
4. A template that provides slots arranged to create spaced-apart slits in the fabric for “weaving” an object (e.g. ribbon, cord, strip, etc.) into the fabric.
5. A template that provides slots arranged to create fringe along an edge of the fabric.
6. A template that provides slots in a wave pattern to create a “wavy” fringe along an edge of the fabric.
7. A template that provides indicia for aligning one or more layers of the fabric in relation to the slots for cutting a desired shape in the fabric.
8. A template having slots configured to receive the ends of a rotary cutting tool.
9. A template that provides contoured external edge surfaces formed in certain patterns for cutting one or more predetermined shapes in a fabric.
10. A template that provides an arcuate edge surface.
11. A template that provides a series of arcuate surfaces (e.g. “scalloped”) along an edge surface.
12. A template formed from a clear, transparent or translucent plastic or other suitable synthetic material for overlaying on a fabric.

### DESCRIPTION OF THE DRAWINGS

FIG. 1 is a schematic representation of a top view of a template according to an exemplary embodiment.

FIG. 2 is a schematic image of a perspective view of the template according to the embodiment of FIG. 1.

FIGS. 3A-3F are schematic images of a material having certain cutouts formed through use of the template according to exemplary embodiments.

FIG. 4A is a block diagram of a method for making a template according to an exemplary embodiment.

FIG. 4B is another block diagram of a method for making a template according to an exemplary embodiment.

### SUMMARY

One aspect of the present invention relates to a template for cutting materials, including a substantially planar sheet having a perimeter. The perimeter has a first edge defining a waveform and a second edge defining a plurality of scallops.

Another aspect of the present invention relates to a template for creating decorative patterns and includes a flat sheet having external guides formed along a perimeter of the sheet and internal guides formed within the perimeter of the sheet. The internal guides include a plurality of slots. A first group of slots define a series of parallel slots, and a second group of slots define a zigzag pattern, and a third group of slots define a waveform pattern.

A further aspect of the present invention relates to a method of making a template. The method includes selecting a sheet of material, and selecting a pattern of external guides having shapes that define a perimeter of the sheet, and selecting a pattern of internal guides having a plurality of slots, and selecting an arrangement of indicia for use with at least one of the guides, and forming the external guides and the internal guides on the sheet.

Yet another aspect of the present invention relates to a template for creating decorative shapes and includes a flat sheet of material having an internal region surrounded by an external edge. The internal region has internal cutting guides formed by slots, where the slots include straight slots, waveform slots and interconnected slots. The external edge defines external cutting guides, which include a waveform edge, a straight edge, an arcuate edge and a scalloped edge.

### DETAILED DESCRIPTION

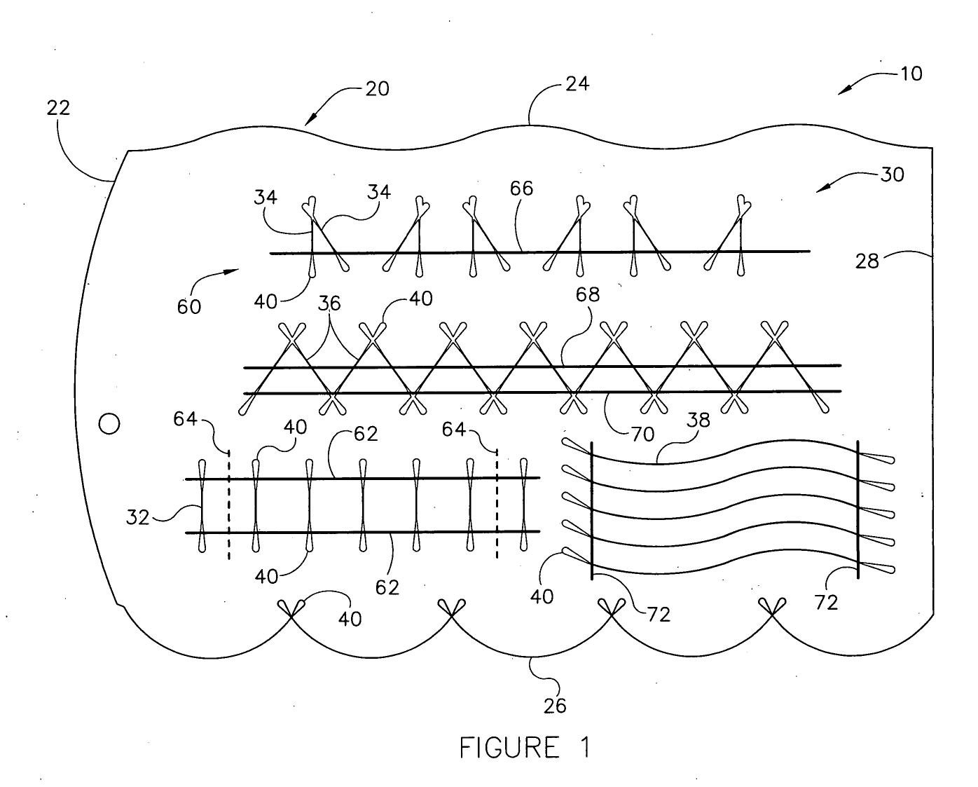

Referring to FIGS. 1-3A-F, a template 10 (e.g. cutting guide, ruler, stencil, pattern, shield, etc.) for cutting a material such as a fabric is shown according to an exemplary embodiment. Template 10 is shown as a piece (e.g. sheet, etc.) of a substantially clear material that includes external cutting guides 20 and internal cutting guides 30 and indicia 60, for use in cutting shapes and patterns into a fabric (such as, for example, a fleece material 50).

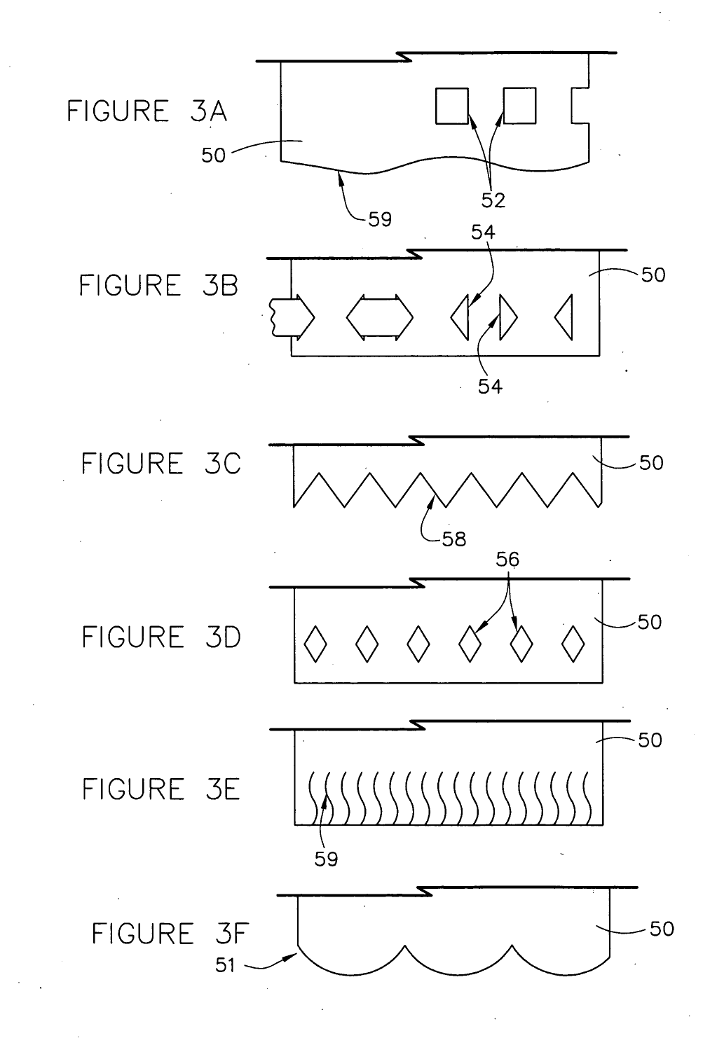

External cutting guides 20 are arranged to substantially define an external edge of the piece and include a curved surface 22, a waveform surface 24, a scalloped surface 26 and a straight surface 28. According to alternative embodiments, the external cutting guides may include other geometric shapes or waveforms having other shapes or sizes. The external cutting guides are aligned on a material at a desired location to provide a guide or template for cutting shapes in the material. Referring to FIG. 3E, for example, a scalloped edge 51 can be made in a material 50 by cutting along the external cutting guide having the scalloped surface 26. Similarly, other shapes can be cut into the material by using the various other external cutting guides (or combinations thereof).

Internal cutting guides 30 are shown to include a plurality of openings. The openings are shown as elongated, relatively narrow openings (e.g. slots, etc.) having various shapes and arrangements.

One internal cutting guide includes a series (e.g. row, etc.) of generally straight parallel slots 32 which are intended to permit a user to cut slits 52 in fabric 50 so that an object (e.g. fabric strip, ribbon, cord, etc.) may be weaved into the fabric (see FIG. 3A). According to one embodiment, the slots are sized approximately one (1) inch long and spaced one (1) inch apart. According to alternative embodiments, the straight slots may be provided in any suitable number, or with any desirable spacing, or at any desirable angle, or in any suitable shape (e.g. “chevrons” etc.).

Another internal cutting guide is shown schematically to include spaced-apart pairs of slots 34 defining an acute angle therebetween. Spaced-apart pairs of slots 34 are intended to permit a user to cut triangles 54 (shown for example as an isosceles triangle) into fabric 50 by folding the fabric and cutting along the slots (see FIG. 3B). The pairs of slots may define any suitable angle (or pattern of angles) and may have any suitable spacing between the pairs.

Another internal cutting guide is shown schematically to include slots 36 that are interconnected in a pattern shown for example as a series of substantially uniform “peaks” and “valleys” (e.g. saw tooth, zigzag, etc.). The pattern of interconnected slots 36 are intended to permit a user to cut geometric shapes shown as a generally “diamond” shape 56 in fabric 50 by folding the fabric and cutting along the slots (see FIG. 3D). The pattern of interconnected slots 36 are also intended to permit a user to cut a zigzag pattern 58 along an edge of the fabric (see FIG. 3C). The interconnected slots may define any suitable angle therebetween (such as a uniform or varying angle pattern) and may define any other suitable geometric shape.

Another internal cutting guide is shown schematically to include a plurality of spaced-apart wave-shaped slots 38. The waveform slots 38 are shown in a “nested” or “stacked” arrangement, but may be provided in any suitable relationship. Wave-shaped slots 38 are intended to permit a user to cut “wavy fringe” 59 in fabric 50 (see FIG. 3E). According to one embodiment, the wave-shaped slots have the same wave form as the waveform of the external cutting guide. According to alternative embodiments, the wave-shaped slots and the waveform of the external guide may be dissimilar, or the slots may be straight to create a “straight fringe” or may have any suitable pattern (e.g. triangular fringe, etc.).

The slots 32, 34, 36, 38 of the internal cutting guides are shown to include an end region 40 (e.g. widened-region, tear-drop opening, receptacle, etc.) at the end of each slot (and at the ends of scallops 26 of external cutting guide 20) that are intended to facilitate use of a rotary-blade type cutting tool (not shown—such as, for example, a 45 mm rotary cutter, etc.). The end region provides space to accommodate the surface of the wheel of a typical rotary-type cutter that extends beyond the point of contact between cutting edge of the wheel and the fabric. End region 40 is shown having a “tear drop” like shape, but may be provided in any suitable shape to accommodate use of a desired cutting tool to provide the desired cutting performance. For example, the end region may be provided as relatively small circular opening(s), or may be omitted entirely, for use with cutting tools such as a razor blade, X-acto knife, etc.

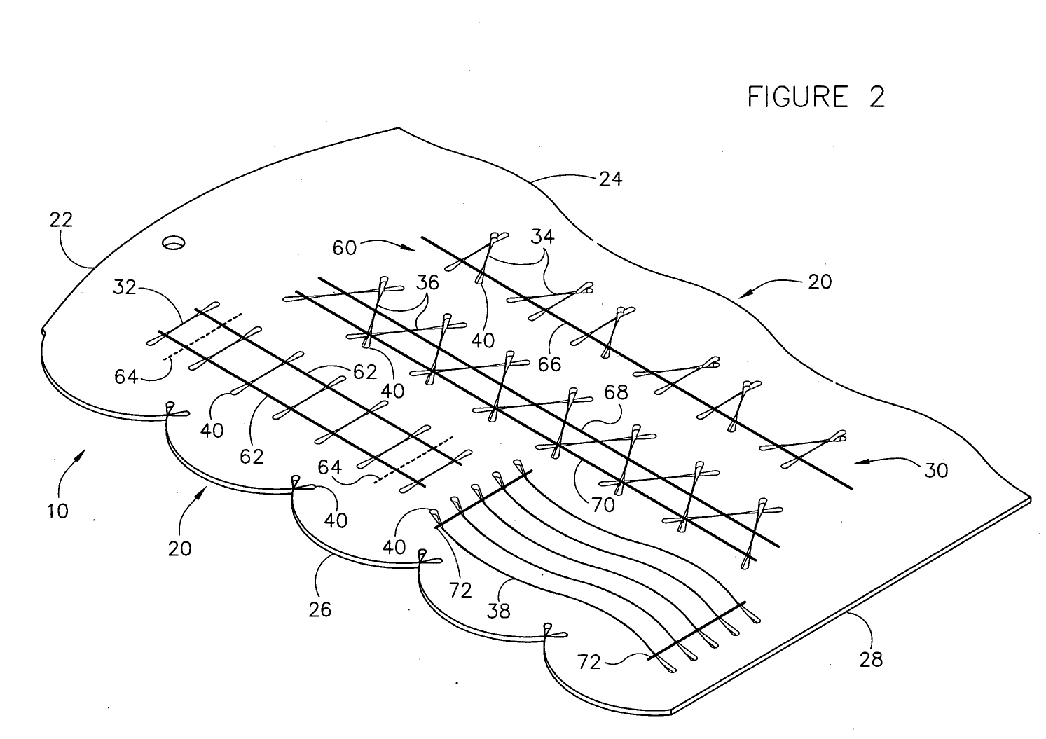

Referring further to FIGS. 1 and 2, indicia 60 (markings, reference lines, guide lines, etc.) are provided on the piece and arranged for use in aligning the internal cutting guides and/or the external cutting guides on the fabric.

Referring to the indicia associated with the series of generally straight parallel slots 32, a guide line 62 is provided extending along the “top” and “bottom” of each of the slots so that a user may layout a series of slits 52 in the fabric (see FIG. 3A). The indicia also includes width indicators 64 to permit a user to establish a desired spacing between slits 52. For example, the fabric may be cut along each slot location, or the fabric may be cut along every-other slot location, or the fabric may be cut along each slot location and then the template shifted over to the “dashed” line indicia 64 and the fabric cut again to “double” the number of slits in the fabric and halve the spacing therebetween. After cutting the fabric along the desired slots, the template may be repositioned on the fabric by lining up the first slot with the last slit cut in the fabric and a user may continue cutting the fabric until the desired number of slits or cuts are made.

Referring to the indicia associated with spaced-apart pairs of slots 34, a guide line 66 is provided along the spaced ends of the pairs of slots 34 so that a user may cut a triangle 54 out of the fabric by folding the fabric and placing slots 34 over the fabric with guide line 66 over the fabric fold line, so that a “folded” triangle 54 of material is cut from the fabric by cutting along the slots of each of the pairs (see FIG. 3B). The size of triangle 54 may be made smaller by spacing the fold line of the fabric away from guide line 66 and toward the junction of slots 34. After cutting the fabric along the desired slots, the template may be repositioned on the fabric by lining up the first pair of slots with the last slits of the triangle cut in the fabric and a user may continue cutting the fabric until the desired number of slits or cuts are made.

Referring to the indicia associated with the pattern of interconnected slots 36, a first guide line 68 is provided along an intermediate position on the pattern, so that a user may cut a diamond shape 56 from the fabric by folding the fabric and placing slots 36 over the fabric with first guide line 68 over the fold line of the fabric (or spaced a suitable distance away from the fold line to vary the size of the diamond shapes—see FIG. 3D) and cutting along slots 36. A second guide line 70 is also provided and is intended to permit a user to cut a zigzag 58 along an edge of the fabric by aligning second guide line 70 with an edge of the fabric and cutting along slots 36. After cutting the fabric along the desired slots, the template may be repositioned on the fabric by lining up the first slot with the last slit or cut in the fabric and a user may continue cutting the fabric until the desired number of slits or cuts are made.

Referring to the indicia associated with the spaced-apart wave-shaped slots 38, a guide line 72 is provided extending along each of the ends of slots 38 so that a user may align guide line 72 with an edge of the fabric and cut along slots 38 to create a fringe 59 (see FIG. 3E). The length of fringe 59 may be adjusted by spacing the edge of the fabric any desired distance from either of guide lines 72. The spaced apart wave-shaped slots may also be used to create slits for weaving another material into the fabric, in the manner previously described for the series of generally straight slots. After cutting the fabric along the desired slots, the template may be repositioned on the fabric by lining up the first slot with the last slit or cut in the fabric and a user may continue cutting the fabric until the desired number of slits or cuts are made.

According to any exemplary embodiment, any suitable indicia may be provided to facilitate, guide, instruct or educate a user in using the template to cut any desired pattern, shape, opening, slit, fringe, etc. using any combination or permutation of one or more of the internal and external cutting guides.

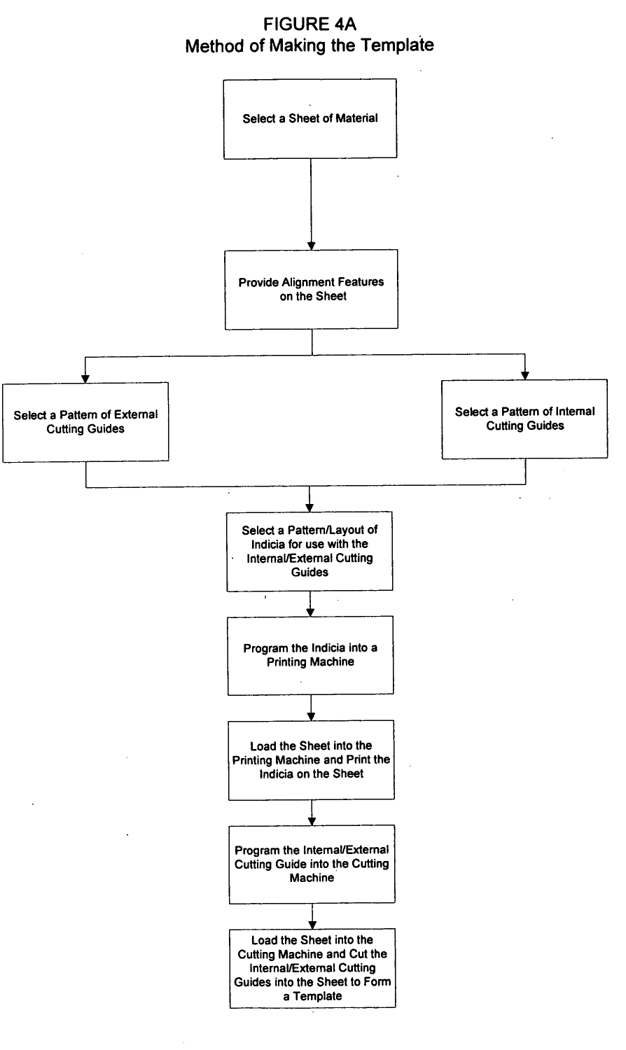

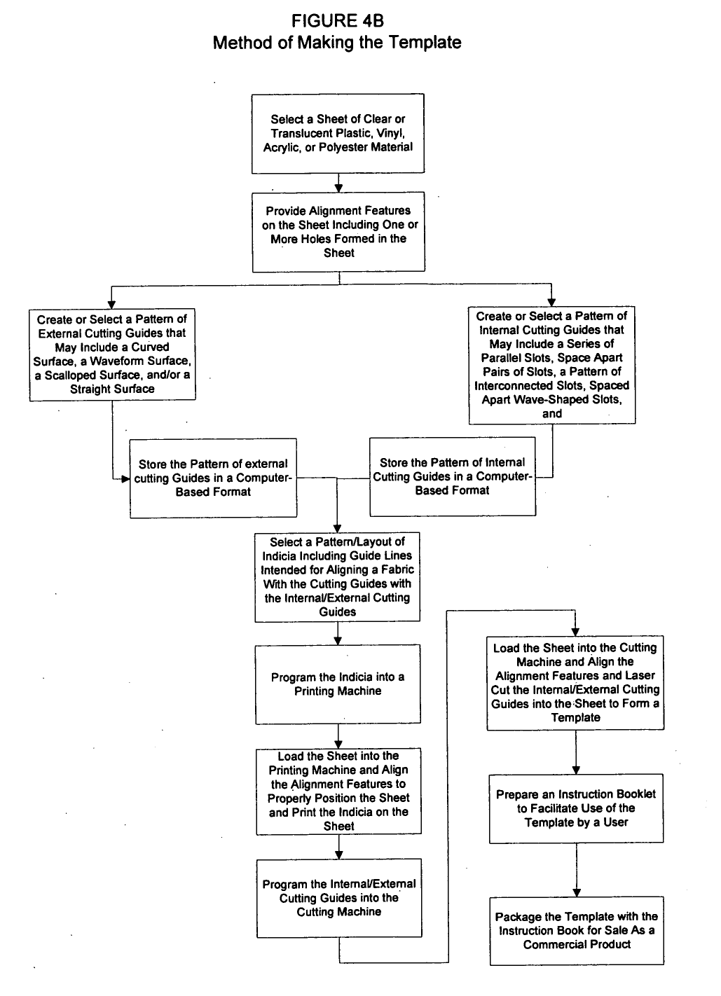

Referring to FIGS. 4A and 4B, a method of making the template is shown according to an exemplary embodiment. A sheet of material for the template is provided and a masking material (e.g. “backer” etc.) is formed from paper with an adhesive on one side that is applied to a first side of the sheet of material. Alignment features such as “locating holes” are formed (e.g. “punched,” cut, drilled, etc.) at predetermined locations within the sheet of material for aligning the sheet on a printing machine and a cutting machine.

A pattern of internal cutting guides and external cutting guides are selected or developed for the template with the external cutting guides generally defining the outer edges or boundaries of the template and the internal cutting guides formed within the boundaries. According to one embodiment, the internal cutting guides are slots having a sufficient width to receive a cutter (e.g. cutting wheel, razor knife, etc.) and have ends with a widened region (e.g. tear drop shaped opening) to accommodate entry and removal of the cutter from the slots. According to a preferred embodiment, the external cutting guides are selected to include a curved (e.g. arcuate, concave, convex, etc.) surface, a waveform surface, a scalloped surface and a straight surface, and the internal cutting guides are selected to include a series of generally straight parallel slots, spaced-apart pairs of slits defining an acute angle therebetween, a pattern of interconnected slits, and spaced-apart wave-shaped slits.

A pattern of indicia are selected or developed for use in association with the internal and external cutting guides to permit a user to cut any one of a variety of shapes or features in a material. The pattern of indicia are loaded into a computer based format and programmed into the printing machine and the sheet of material is loaded and aligned on the printing machine and the indicia is printed on the sheet of material.

The pattern of internal and external cutting guides are loaded into a computer based format and programmed into a cutting machine and the sheet of material is removed from the printing machine and is loaded and aligned on the cutting machine. The internal and external cutting guides are cut into the sheet of material to create a piece of material in the form of a template having the external cutting guides substantially defining the outer edges of the template with the internal cutting guides formed within.

An instructional booklet (e.g. pamphlet, instruction sheet, etc.) may be prepared for use by a user to facilitate use of the template. The booklet may be printed in black and white, or in color, and provide instructions, illustrations and/or examples of decorative shapes or features that may be cut into a material such as a fleece material. The instructional booklet may be package with the template for commercial sale in wholesale or retain market outlets.

According to an exemplary embodiment, the sheet of material is a sheet of PETG material (a glycolised polyester material) or other suitable polyethylene terephthalate (PET) based material having a thickness within a range of approximately 1/16 inch to ⅛ inch and more particularly approximately 3/32 inch thickness and provided in a substantially clear or decorative color. According to alternative embodiments, the sheet of material may be any suitable plastic, vinyl, acrylic, polyester or other suitable synthetic material (or even a thin metallic material) of any desired thickness and may be provided in any suitable color and may having varying degrees of transparency or translucency.

The external and internal cutting guides may be cut in the sheet of material using any suitable cutting technique. According to a preferred embodiment, the external and internal cutting guides are laser-cut in the sheet of material using a laser cutting machine such as a 500 watt CO2 laser commercially available from Beam Dynamics as model no. LMC 500. The indicia may be printed on the template using any suitable printing technique. According to a preferred embodiment, the indicia are screen printed onto the sheet of material using any suitable screen printing machine, such as a model MP commercially available from Medallion, or a model Viking commercially available from American Screen Printing.

According to any preferred embodiment, one aspect of the present invention relates to a template for cutting a material. The template includes internal cutting guides and external cutting guides. Indicia are marked on the template for aligning at least one of the internal cutting guides and the external cutting guides on the material. The internal cutting guides may include a series of spaced-apart slots. The internal cutting guides may include at least one wave-shaped slot. The internal cutting guides may include a plurality of interconnected slots arranged in a pattern. The pattern may be a geometric shape. The material may be a fleece material. The template may be formed from a clear plastic, vinyl, polyester or acrylic material.

According to any preferred embodiment, another aspect of the present invention relates to a method for making a template for use in cutting a fabric. The method includes providing a sheet of material, arranging a pattern for cutting the sheet of material to include internal guides and external guides, cutting the sheet of material into a piece defined along its edges by the external guides and having slots within the edges to define the internal guides. The method may also include masking the sheet of material. The method may also include printing indicia on the sheet of material The printing may be screen printing. The cutting may be performed by laser cutting. The material may be a PETG material. The method may also include removing the masking and packaging the piece. The method may also include selecting or creating patterns for internal and/or external cutting guides. The method may also include preparing an instruction booklet to facilitate use of the template, and packaging the template with the instruction booklet for commercial sale.

It is also important to note that the construction and arrangement of the elements of the template and method for making a template as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various cutting guides, values of parameters, layout arrangements, use of materials, colors, orientations, etc.) without materially departing from the novel teachings and advantages of the subject matter recited. For example, the arrangement of the internal and/or external cutting guides may be reversed or otherwise varied, the length, shape or width of the cutting guides may be varied, the nature or number of internal or external cutting guides and/or indicia associated with the cutting guides may be varied (e.g. by variations in the number of slots, shapes or orientation of the indicia, modification of the end regions of the slots, etc.). It should be noted that the template may be constructed from any of a wide variety of materials that provide sufficient strength or durability and are suited for manufacture in a desired cutting process, and in any of a wide variety of colors, textures and combinations. Accordingly, all such modifications-are intended to be included within the scope of the present inventions. Other substitutions, modifications, changes and omissions may be made in the design, operating conditions and arrangement of the preferred and other exemplary embodiments without departing from the spirit of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present inventions.

What is claimed is:

1. A template for cutting materials, comprising:
a substantially planar sheet having a perimeter, the perimeter comprising a first edge defining a waveform and a second edge defining a plurality of scallops.

2. The template of claim 1 wherein the perimeter further comprises a third edge defining an arc.

3. The template of claim 2 wherein the perimeter further comprises a fourth edge defining a straightedge.

4. The template of claim 3 wherein the first edge and the second edge and the third edge and the fourth edge are contiguous.

5. The template of claim 1 wherein the sheet further comprises a plurality of slots disposed within the perimeter.

6. The template of claim 5 wherein the slots comprise at least one wave-shaped slot.

7. The template of claim 5 wherein the slots comprise parallel slots.

8. The template of claim 5 wherein the slots comprises interconnected slots that form a zigzag pattern.

9. The template of claim 5 wherein the slots comprise V-shaped slots.

10. The template of claim 5 wherein the slots further comprise a receptacle configured to accommodate a rotary cutting tool.

11. The template of claim 5 wherein the sheet further comprises indicia marked thereon, the indicia configured to facilitate cutting at least one layer of fabric by aligning the fabric with the indicia.

12. A template for creating decorative patterns, comprising:
a substantially flat sheet having a plurality of external guides formed along a perimeter of the sheet and a plurality of internal guides formed within the perimeter of the sheet, the internal guides comprising a plurality of slots, wherein a first group of slots define a series of parallel slots and a second group of slots define a zigzag pattern and a third group of slots define a waveform pattern.

13. The template of claim 12 further comprising a fourth group of slots arranged in a plurality of V-shaped formations.

14. The template of claim 12 wherein at least one end of the slots comprise a teardrop shaped opening.

15. The template of claim 12 further comprising a pattern of markings on the sheet configured to facilitate layout of the template on a material.

16. The template of claim 12 wherein the external guides comprise a waveform.

17. The template of claim 12 wherein the external guides comprise a plurality of scallops.

18. The template of claim 12 wherein the external guides comprise an arc.

19. A method of making a template, comprising:
selecting a sheet of material;
selecting a pattern of external guides comprising shapes defining a perimeter of the sheet;
selecting a pattern of internal guides comprising a plurality of slots;
selecting an arrangement of indicia for use with at least one of the guides; and
forming the external guides and the internal guides on the sheet.

20. The method of claim 19 wherein the external guides comprise a scallop pattern.

21. The method of claim 19 wherein the external guides comprise a waveform.

22. The method of claim 19 wherein the internal guides comprise a series of parallel slots.

23. The method of claim 19 wherein the internal guides comprise a pattern of interconnected slots.

24. The method of claim 19 wherein the internal guides comprise a pattern of spaced-apart V-shaped slots.

25. The method of claim 19 wherein the internal guides and the external guides are formed by laser cutting.

26. The method of claim 19 further comprising printing indicia on the sheet that are configured to align the guides in a desired position on a material to be cut.

27. The method of claim 19 further comprising forming a receptacle adjacent to at least one of the guides, the receptacles configured to accommodate use of a rotary cutting tool.

28. A template for creating decorative shapes, comprising: a flat sheet of material having an internal region surrounded by an external edge, the internal region comprising internal cutting guides formed by a plurality of slots, the plurality of slots including straight slots, waveform slots and interconnected slots, and the external edge defining external cutting guides comprising a waveform edge, a straight edge, an arcuate edge and a scalloped edge.

29. The template of claim 28 wherein the straight slots comprise parallel straight slots.

30. The template of claim 28 wherein the waveform slots comprise nested waveform slots.

31. The template of claim 28 wherein the waveform edge, the straight edge, the arcuate edge and the scalloped edge are contiguous.
